(19) United States
(12) Patent Application Publication
(10) Pub. No.: US 2012/0109728 A1
(43) Pub. Date: May 3, 2012

(54) INCENTIVES FOR MEDIA SHARING

(75) Inventor: David L. Sparks, Cupertino, CA (US)

(73) Assignee: GOOGLE INC., Mountain View, CA (US)

(21) Appl. No.: 13/270,291

(22) Filed: Oct. 11, 2011

Related U.S. Application Data
(60) Provisional application No. 61/408,339, filed on Oct. 29, 2010.

(51) Int. Cl. G06Q 30/02

(52) U.S. Cl. 705/14.16

(57) ABSTRACT

Methods, systems, and apparatus, including computer programs encoded on a computer storage medium, for providing incentives for media sharing. In one aspect, a method includes receiving a request from a first user to share a media item with a second user, and providing the second user with access to the media item. The method includes determining that the second user has performed an action related to the media item, and in response to determining that the second user has performed the action related to the media item, accessing a referral attribute associated with the first user, the referral attribute being related to the action. The method includes comparing the referral attribute to a reference value, based on comparing the referral attribute to the reference value, determining an amount of referral credit, and providing the determined amount of referral credit to the first user.

### CROSS REFERENCE TO RELATED APPLICATION

This application claims priority to U.S. Provisional Application No. 61/408,339 filed on Oct. 29, 2010. The entire contents of U.S. Provisional Application No. 61/408,339 are incorporated herein by reference.

### TECHNICAL FIELD

This document generally relates to incentives for media sharing.

### BACKGROUND

Media sharing among consumers may introduce consumers to new media which may lead to media purchases. By encouraging consumers to share media, media providers may be able to effectively market their products.

### SUMMARY

In some implementations, it can be determined when users that receive shared media items perform actions related to the shared media items (for example, when users view or purchase the shared media items). In response to determining that an action was performed for a shared media item, a referral attribute for the user that shared the media item can be accessed. Using the referral attribute, an amount of referral credit is determined. The determined amount of referral credit is then provided to the user that shared the media item.

In one general aspect, a method includes: receiving a request from a first user to share a media item with a second user; in response to receiving the request from the first user to share the media item, providing the second user with access to the media item; determining that the second user has purchased rights to the media item; in response to determining that the second user has purchased rights to the media item, accessing a referral attribute associated with the first user, the referral attribute being related to the action and being based on correlations among (i) other requests by the first user to share media and (ii) actions by users that, in response to the other requests, receive access to the media; comparing the referral attribute to a reference value; based on comparing the referral attribute to the reference value, determining an amount of referral credit such that a first amount of the referral credit is determined if the referral attribute is greater than the reference value, and a second amount of the referral credit is determined if the referral attribute is less than the reference value, the second amount of referral credit being less than the first amount of referral credit; and providing the determined amount of referral credit to the first user.

These and other embodiments may each optionally include one or more of the following features. For example, providing the second user with access to the media item includes providing the second user with access to the media item a limited number of times. Determining an amount of referral credit includes determining an amount of referral credit based on the age or popularity of the media item, wherein the amount of referral credit is inversely correlated with the age or popularity of the media item. The referral attribute includes a monetary value of purchases or number of purchases of rights to one or more media items, the purchases being correlated with one or more requests by the first user that each of the one or more media items be shared with one or more other users, the monetary value of purchases or number of purchases including information about at least one purchase by a user with whom the first user did not request that the media item be shared.

Determining an amount of referral credit includes adding a supplemental amount of referral credit to a base value of referral credit, the supplemental amount of referral credit being based on the comparison. Determining an amount of referral credit includes multiplying a base value of referral credit by a scaling factor based on the comparison. The referral attribute includes a monetary value of purchases or number of purchases of rights to the media item by users with whom the first user has requested the media item be shared. The reference value includes, for a set of users that have requested that the media item be shared, an average monetary value of purchases or average number of purchases of rights to the media item by users with whom at least one of the set of users has requested the media item be shared.

The referral attribute includes a monetary value of purchases or number of purchases of rights to at least one of a plurality of media items by users with whom the first user has requested the at least one of the plurality of media items be shared. The reference value includes an average monetary value of purchases or average number of purchases of rights to at least one of the plurality of media items by users with whom a plurality of users have requested at least one of the media items be shared. The referral attribute includes a percentage of requests from the first user to share at least one of a plurality of media items resulting in a purchase of rights to the at least one of the plurality of media items by a user with whom the first user has requested that the at least one of the plurality of media items be shared. The referral attribute includes a number of users that have accessed the media item out of a set of users with whom the first user has requested the media item be shared.

In another general aspect, a method includes receiving a request from a first user to share a media item with a second user; in response to receiving the request from the first user to share the media item, providing the second user with access to the media item; determining that the second user has performed an action related to the media item; in response to determining that the second user has performed the action related to the media item, accessing a referral attribute associated with the first user, the referral attribute being related to the action and being based on correlations among (i) other requests by the first user to share media and (ii) actions by users that, in response to the other requests, receive access to the media; comparing the referral attribute to a reference value; based on comparing the referral attribute to the reference value, determining an amount of referral credit; and providing the determined amount of referral credit to the first user.

These and other embodiments may each optionally include one or more of the following features. Providing the second user with access to the media item includes providing the second user with access to the media item a limited number of times. Determining an amount of referral credit includes determining an amount of referral credit based on the age or popularity of the media item, and the amount of referral credit is inversely correlated with the age or popularity of the media item. The action related to the media item includes purchasing rights to the media item. The referral attribute includes a monetary value of purchases or number of purchases of rights to one or more media items, the purchases being correlated with one or more requests by the first user that each of the one or more media items be shared with one or more other users, the monetary value of purchases or number of purchases including information about at least one purchase by a user with whom the first user did not request that the media item be shared.

Determining an amount of referral credit using the referral attribute includes adding a supplemental amount of referral credit to a base value of referral credit, the supplemental amount of referral credit being based on the comparison. Determining an amount of referral credit using the referral attribute includes multiplying a base value of referral credit by a scaling factor based on the comparison. The referral attribute includes a monetary value of purchases or number of purchases of rights to the media item by users with whom the first user has requested the media item be shared.

The reference value includes, for a set of users that have requested that the media item be shared, an average monetary value of purchases or average number of purchases of rights to the media item by users with whom at least one of the set of users has requested the media item be shared; and determining an amount of referral credit includes determining a first amount of the referral credit if the referral attribute is greater than the reference value and determining a second amount of the referral attribute is less than the reference value, the first amount being greater than the second amount. The referral attribute includes a monetary value of purchases or number of purchases of rights to at least one of a plurality of media items by users with whom the first user has requested the at least one of the plurality of media items be shared.

The reference value includes an average monetary value of purchases or average number of purchases of rights to at least one of the plurality of media items by users with whom a plurality of users have requested at least one of the media items be shared; and determining an amount of referral credit includes determining a first amount of the referral credit if the referral attribute is greater than the reference value and determining a second amount of the referral attribute is less than the reference value, the first amount being greater than the second amount. The referral attribute includes a percentage of requests from the first user to share at least one of a plurality of media items resulting in a purchase of rights to the at least one of the plurality of media items by a user with whom the first user has requested that the at least one of the plurality of media items be shared. The action related to the media item includes accessing the media item. The referral attribute includes a number of users that have accessed the media item out of a set of users with whom the first user has requested the media item be shared.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more implementations are set forth in the accompanying drawings and the description below. Other potential features and advantages will become apparent from the description, the drawings and the claims.

### BRIEF DESCRIPTION OF THE DRAWINGS

FIG. 1 is a diagram illustrating an example of a system that provides incentives for media sharing.

FIG. 2 is a diagram illustrating an example of a message that can be provided by a system that provides incentives for media sharing.

FIG. 3 is a flow chart illustrating an example of a process for providing incentives for media sharing.

FIG. 4 is a table illustrating examples of information used by a system for media sharing.

FIG. 5 is a block diagram of computing devices that may be used to implement the systems and methods described in this document, as either a client or as a server or plurality of servers.

FIG. 6 is a diagram illustrating a network of users.

### DETAILED DESCRIPTION

This document describes techniques for providing incentives for people to share media with others. For instance, a user can request that a media item be shared with a recipient, and access to the media item is provided to the recipient. When the recipient performs an action related to the shared media item, for example viewing or purchasing the shared media item, a value of referral credit based on the action is determined and provided to the user that shared the media item.

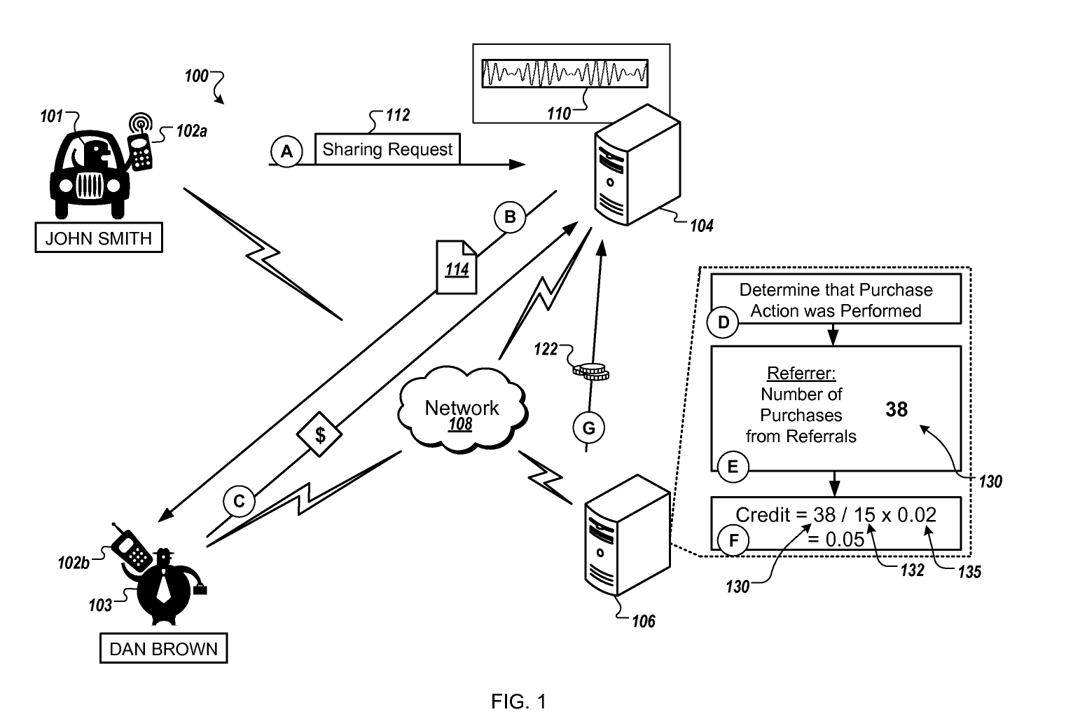

FIG. 1 is a diagram illustrating an example of a system that provides incentives for media sharing. FIG. 1 also illustrates a flow of data, shown in states (A) to (G), which may occur in the illustrated sequence, or may occur in a sequence that is different than the illustrated sequence. States (D) to (F) illustrate a flow of data processing, and also may occur in the sequence shown or another sequence.

In general, to encourage media sharing, a server system receives a request from a first user to share a media item with a second user, and in response to receiving the request, provides the second user with access to the media item. The server system in system 100 determines that the second user has performed an action related to the media item (such as viewing the media item or purchasing rights to the media item), and in response, the server system accesses a referral attribute associated with the first user, the referral attribute also being related to the action. The server system determines an amount of referral credit using the referral attribute, and provides the determined amount of referral credit to the first user. By providing referral credit in this manner, the system 100 may encourage users to share media items that will be viewed, purchased, or otherwise acted on by users that receive the shared media items. In addition, the amount of referral credit can be determined to provide increased incentive to, for example, (i) users whose sharing is frequently results in purchases of rights to content by recipients and (ii) users that can influence others to purchase media items that are new or are not well known.

In particular, the system 100 includes client devices 102a, 102b, a media server 104, and a referral server 106, connected to each other by a network 108. Each of the client devices 102a, 102b can be a smart phone, tablet computer, notebook computer, desktop computer, or other device that can access media. Each client device 102a, 102b is capable of displaying or reproducing media items in some form, and is also capable of receiving and transmitting media items.

The media server 104 provides access to media items and manages rights to access media items. Media may include, for example, one or more of text, images, video, audio, and other creative expressions. A media item, which may be an identifiable unit of media, such as a specific song, album, movie, or other creative work. A media item can include only a portion of a creative work. The media server 104 may store media, such as a media item 110.

The media server 104 can enable media items to be downloaded or streamed to a client device 102a, 102b. The media server 104 can also determine whether a user (or a client device 102a, 102b associated with a user) possesses sufficient rights to access media items, and can restrict access if rights are insufficient.

The referral server 106 tracks referrals of media items and provides referral credit. The amount of referral credit provided is based, at least in part, on a referral attribute of the user that refers a media item to others. For example, the referral server 106 can determine when an action is performed related to a shared media item, such as when the media item is purchased. Using information about the user that shared the media item (a referral attribute of the user), the referral server 106 can increase the amount of referral credit for the user that shared the media item when the user is very influential. For example, the referral server 106 can award an amount of referral credit above a base referral credit amount. The referral server 106 may determine the influence of a user, for example, as reflected in a referral attribute of the user, by identifying the actions of recipients of media items from the user that are correlated to referrals by the user.

Although the media server 104 and the referral server 106 perform different logical functions, the functions can be performed in a single server system. Alternatively, the functionality of the media server 104 and referral server 106 can be distributed among many server systems, such as in a datacenter. In addition, the referral server 106 and media server 104 can share access to common databases of information, allowing both the referral server 106 and media server 104 access to information about referrals and accesses to media items.

The network 108 may be wired or wireless, and may include a packet-based network, such as a TCP-IP network. The network 108 may include a local area network, wide area network, or the Internet.

The following describes an example of the operation of system 100. During state (A), a referrer 101 named John Smith, the user of client device 102a, requests that a media item 110 be shared with a recipient 103 named Dan Brown, the user of client device 102b. For example, to share the media item 110, the referrer 101 may select a recipient 103 and a media item 110. The referrer 101 may then select a control that causes the client device 102a to send a sharing request 112.

The sharing request 112 can include information identifying the referrer 101, information identifying the recipient 103, and information identifying the media item 110 to be shared. Information identifying a referrer 101 or recipient 103 may include a name, user name, email address, phone number, code, or other identifier. Information identifying the media item 110 may include, for example, a product number, title, hash code, or other identifier. The information identifying the media item 110 may vary depending on the type of media. Examples include a title, artist and/or album for a song, an identification code for a movie, and an ISBN number for a book.

In some instances, the sharing request 112 may include a portion of or all of the media item 110. Including the media item 110 in the sharing request 112 may enable sharing even when the media item 110 is not widely available, such as when the media item 110 is user-generated.

During state (B), the media server 104 receives the sharing request 112 and provides the recipient 103 with access to the media item 110. The media server 104 may provide access to the media item 110 by, for example, streaming the media item 110 to the client device 102b. The media server 104 may also provide access by adding a copy of the media item 110 to a media storage unit of the media server 104, the client device 102b, or another system. The media server 104 may also provide access by providing a link to a media item 110, by enabling a file to be downloaded to the client device 102b, or by adding a reference to the media item 110 in a playlist or media library of the recipient 103. The media server 104 may include access information and information identifying the referrer 101 in an access message 114 transmitted to the client device 102b. The media server 104 may limit access to the media item 110 by the recipient 103, such as using digital rights management (DRM) techniques.

As noted above, the media server 104 may limit the recipient's access to the media item 110 by imposing access restrictions. In general, the access restrictions may be imposed until the recipient 103 purchases or otherwise acquires rights to unrestricted access of the media item 110. The access restrictions may, for example, limit the number of times the media item 110 can be accessed by the recipient 103. Access restrictions may also limit the duration of time that the recipient 103 receives access to the media item 110, such as by setting a date after which access to the media item 110 is discontinued. Access restrictions may limit access to the specific client device 102b or may allow limited access on multiple client devices associated with the recipient 103.

Access restrictions may also limit the extent of access to the media item 110. For example, access restrictions may allow access to only a portion of the media item 110, limit the level of quality the media item 110 (such as restricting access to low-bitrate audio or low resolution video rather than higher-quality versions of the media item 110), or require advertisements to accompany the media item 110.

To enforce access restrictions, the media server 104 may track accesses to the media item 110. In implementations in which the media item 110 is streamed from the media server 104 to the client device 102b, the media server 104 may track each access to the media item 110 and may deny access once the recipient 103 is no longer authorized to access the media item 110.

In implementations in which the media item 110 is stored on the client device 102b, the media server 104 may provide to the client device 102b a file, such as an access message 114, that includes the media item 110. The access message 114 may include a license token that must be validated by the media server 104 before the media item 110 can be accessed. Additionally, the system 100 may require the license token to be verified before each access to the media item 110. Alternatively, the media server 104 may provide to the client device 102b a file including the media item 110 and the access restrictions, and the client device 102b may track accesses to the media item 110 and enforce the access restrictions.

In providing access to the media item 110, the media server 104 also may provide to the client device 102b information identifying the referrer 101. The information identifying the referrer may be transmitted in metadata of a message, file, bitstream, or other data provided to the client device 102b. The media server 104 may also provide additional information along with the media item 110, as described in greater below.

In some implementations, the media server 104 may provide access to the media item 110 in response to receiving a sharing request 112 only if the referrer 101 had rights to access the media item 110 at the time the sharing request 112 was sent or if the referrer 101 at one time had rights to the media item 110 (such as if the user had previously rented a movie but the rental period has expired). In other words, a referrer 101 may be allowed to share the media item 110 only if the referrer 101 has rights to access the media item 110. The media server 104 may determine the rights of the referrer 101 related to the media item 110 before fulfilling the sharing request 112. Alternatively, the media server 104 may provide access to the media item 110 even if the referrer 101 is not known to possess any rights to the media item 110.

During state (C), the recipient 103 performs an action related to the media item 110. In the illustration, the recipient 103 purchases rights to access the media item 110.

While the action illustrated is a purchase, many other actions related to the media item 110 are possible. Examples of actions related to the media item 110 include downloading, viewing, playing, displaying, and otherwise accessing the media item 110. Other examples include renting, purchasing, or borrowing rights to the media item 110, providing reviews or ratings of the media item 110, or referring the media item 110 to other users. Purchasing rights to access the media item 110 for another user is an action, as is receiving rights to the media item 110 in the form of a gift. In addition, accessing media item 110 in part may be considered a different action than accessing the media item 110 in its entirety.

An action related to the media item 110 may also include an action performed not only on the shared media item 110, but also on other media items related to the shared media item 110. For example, the shared media item 110 received by a recipient 103 may include a movie. The recipient 103 may subsequently purchase rights to access the movie and a sequel to the movie. The purchase of rights to the movie may be one action related to the shared media item 110, and the purchase of the sequel may be a second action related to the shared media item 110 because the sequel is logically related to the shared media item 110. Similarly, a referrer 101 may request that a first song by a particular artist be shared with a recipient 103. If the recipient 103 subsequently purchases a second song by the same artist as the first song, the purchase may be considered an action related to the shared first song because the two songs have the same artist. It may be inferred, for example, that sharing the first song influenced the recipient 103 to preview and purchase the second song because the two songs share a common artist.

Actions related to the media item 110 may be recorded or detected by the media server 104. For example, the media server 104 may record an entry in an access database indicating that the media item 110 was streamed to the client device 102b associated with the recipient 103. The access database may be accessed by the referral server 106 so that referral credit may be provided based on the action. To facilitate providing referral credit, the media server 104 may associate information identifying the referrer 101 with entries indicating actions related to the media item 110.

Additionally, or alternately, the client device 102b or media server 104 may send a message to the referral server 106 indicating that an action related to the media item 110 has been performed. The message may include information identifying the media item 110, information identifying the type of action performed, information identifying the referrer 101, and information identifying the recipient 103 that performed the action.

During state (D), the referral server 106 determines that an action related to the media item 110 has been performed. Determining that an action related to the media item 110 has been performed may include determining the type of action that has been performed. For example, the referral server 106 determines that the recipient 103 has performed an action related to the media item 110 and determines that the action performed was a purchase.

To determine that an action related to the media item 110 has been performed, the referral server 106 may access information in a database. For example, the referral server may access a database of accesses to media items associated with the media server 104. An entry in the database may indicate that the recipient 103 played the media item 110, enabling the referral server 106 to determine that an action was performed, determine the type of action that was performed, determine the identity of the recipient 103 that performed the action, and the identity of the referrer 101 that requested that the media item 110 be shared.

The referral server 106 may also determine that an action has been performed by receiving and processing a message from the client device 102b or media server 104 indicating that an action has been performed.

During state (E), the referral server 106 accesses a referral attribute 130 of the referrer 101. Accessing the referral attribute 130 can include determining or generating the referral attribute or accessing a stored value of the referral attribute 130. This may be done, for example, in response to determining that the recipient 103 performed an action related to the media item 110. Rather than awarding an equal amount of referral credit to every user that refers media items, the system 100 can provide referral credit based, at least in part, on information about the referrer 101. In other words, the referral attribute 130 can include information about the referrer 101 that is related to the action performed by the recipient 103. For example, when the action of the recipient 103 is a purchase, the referral server 106 can access information about the referrer 101 that relates to purchases, such as a number of purchases (e.g., “38”) that have resulted from requests by the referrer 101 to share one or more media items. Thus the referral attribute can be based on correlations among requests by the referrer 101 to share media and actions of users that, because of the requests, receive access to the media.

The referral attribute 130 is associated with the referrer 101, meaning that it is based at least in part on information about the referrer 101. For instance, the referral attribute 130 illustrated is the number of purchases of media items resulting from requests by the referrer 101 to share media. In other words, the referral attribute 130 is the number of times that any user purchased any media item that the particular referrer 101 shown had previously requested to be shared with a user.

A purchase may be considered to result from a referral of a media item 110 when a referrer 101 requests that a media item 110 be shared with the recipient 103 and the recipient 103 subsequently purchases rights to access the media item 110. Similarly, a request by a referrer 101 to share a media item 110 results in a purchase by the recipient 103 when the recipient 103 purchases rights to the media item after receiving access to the media item 110.

The number of purchases by recipients 103 resulting from requests to share media items 110 by a referrer 101 may be stored by the media server 104 or the referral server 106. The referral server 106 may calculate the number of purchases by accessing a history of requests to share media items 110 of a referrer 101 and accessing a transaction history of the recipients 103 that received the media items 110. The referral attribute 130 may be stored by the media server 104 or the referral server 106 and be associated with the referrer 101.

The referral attribute 130 may be based on actions related to, such as purchases of, multiple different media items by multiple recipients. Alternatively, the referral attribute 130 may be based on purchases of a single media item 110 by multiple recipients, which may be useful, for example, in determining if a referrer 101 has unusually high success at sharing a particular media item 110 with recipients that will purchase that media item.

A referral attribute 130 can also be based on actions performed with respect to a media item 110 by a user with whom the referrer 101 did not directly share the media item 110. For example, a referrer 101 may share the media item 110 with a recipient 103, and the recipient 103 may then share the media item with a third user. The purchase by the third user was influenced by the initial sharing of the media item 110 with the direct recipient 103, even though the third user received the media item 110 indirectly. The referral server 106 may include in a referral attribute 130 for the referrer 101 information about an action related to the media item 110 that was performed by the third user, even though the third user only indirectly received the media item from the referrer 101.

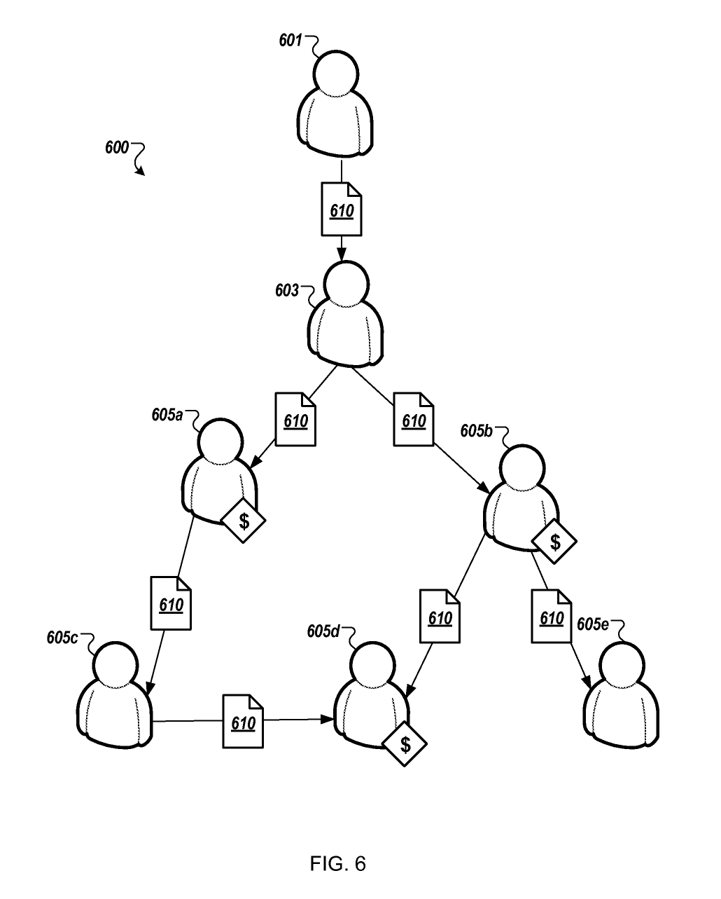

For example, FIG. 6 illustrates how a particular referrer 601 can have a significant effect on a network 600 of users. The referrer 601 only shares a media item 610 with one direct recipient 603. That direct recipient 603 then shares the media item 610 with indirect recipients 605a, 605b, who in turn share the media item with indirect recipients 605c-605e. Even though the direct recipient 603 does not purchase the media item 610, three indirect recipients 605a, 605b, 605d do purchase the media item. The influence of the referrer 601 thus extends beyond the scope of the initial direct recommendation to the direct recipient 603.

To measure the total influence of the referrer 601, a referral server (not shown) may identify actions by both the direct recipients 603 and the indirect recipients 605a-605e. For example, the referral server can identify the direct recipients 603 and the indirect recipients 605a-605e, and then identify actions related to the media item 610 performed by all recipients 603, 605a-605e after having received the media item 610 that originated from the referrer 601. The referral server can thus correlate initial requests by the referrer 601 that the media item 610 be shared with resulting actions related to the media item 610 across a network of users. In one implementation, the referral server can correlate actions based on a direct chain of referrals from one recipient 603, 605a-605e to another.

The referral server can calculate an overall measure of the influence of the referrer 601, for example, a total number of sales or monetary value of sales that result from one or more requests to media items. This measure of influence, with respect to a particular media item 610 or a set of multiple media items, can be used as a referral attribute of the referrer 601, which can be used to determine an amount of referral credit that the referrer receives for one or more actions related to media items.

Referring again to FIG. 1, during state (F), the referral server 106 determines an amount of referral credit to provide to the referrer 101. Determining the amount of referral credit is based, at least in part, on the referral attribute accessed state (E). The system 100 may be configured to provide greater incentives to share media, in the form of increased referral credit, to referrers 101 that are highly influential. In particular, the system 100 can be configured to provide increased referral credit to early influencers, for example, those that demonstrate influence on others early in the market cycle of media items 110. For example, a referrer 101 that influences others to view or purchase a media item 110 while the media item 110 is relatively new or not widely known may be rewarded more than a referrer that influences others to view or purchase the same media item 110 after it is already popular and widely known.

In one implementation, a base amount of referral credit may be determined for a referrer 101 when a recipient 103 performs an action is performed related to a shared media item 110. An increased amount of referral credit, or an amount above a base amount, may be determined when the referrer 101 has above-average influence. The increase in referral credit may exhibit a non-linear relationship with the referral attribute 130 so that the referrers 101 with the highest influence receive much more referral credit than referrers 101 that simply have above-average influence.

For example, the referral server 106 may determine an amount of referral credit by multiplying the base amount by a scaling factor that is based on one or more referral attributes 130 of the referrer. As another example, the referral server 106 may determine a supplemental amount of referral credit to add to the base amount of referral credit, with the supplemental amount determined based on one or more referral attributes 130. Regardless of the method of calculation, the referral credit can be determined according to the degree of influence reflected in the referral attribute 130.

The referral server 106 can use a reference value 132 to determine the amount of referral credit. The reference value 132, like the referral attribute 130, is also related to the action determined during state (D). The reference value 132 can be, for example, an average number of purchases per referrer that resulted from the media sharing of multiple referrers. For instance, an average may be calculated by taking the number of purchases of media items by users with whom the purchased media items had previously been shared and dividing by that number by the number of users that had requested that a media item be shared. A reference value 132 may also reflect an average referral attribute 130 for a set of users.

Using a reference value 132 based on data for multiple referrers 101 may enable the administrators of the system 100 to identify referrers 101 that are the most influential. Influential referrers 101 may be those whose requests to share one or more media items 110 with recipients 103 are most likely to result in recipients 103 performing an action related to the media items 110, such as purchasing rights to access the media items 110. Influence may be measured by the frequency, consistency, number, or monetary value of actions performed related to media items 110 by recipients 103.

The reference value 132 may be calculated by accessing the selected referral attribute 130 for each of the multiple referrers 101 and by generating an average of the referral attributes. Alternately, the reference value 132 may be calculated without accessing referral attributes by instead accessing data about individual transactions linked to shared media items 110. Of course the reference value 132 may also be stored for quick access and retrieved rather than being calculated before each comparison.

An average may include one of an arithmetic mean, geometric mean, median, weighted sum, and measures to typify a set of values. In addition, an average is not required to be exact or to be updated instantly. An average value may be used for a period of time and be updated only occasionally. Approximate values or values calculated on only a subset of all the data available may achieve the similar results to a perfect average while avoiding unnecessary complexity and computation.

The referral server 106 can compare the referral attribute 130 with the reference value 132 to determine the degree of influence of the referrer 101, for example, to determine whether the referrer 101 has above-average influence. The referral server 106 can use the reference value 132 to determine a scaling factor that is used to determine the amount of referral credit. For example, the referral server 106 may calculate a scaling factor by dividing the value of the referral attribute 130 by the value of the reference value 132. The referral server 106 can then multiply the scaling factor by a base amount of referral credit to calculate the amount of referral credit. For example, as illustrated, the referral attribute 130 may be 38, and the reference value 132 (an average number of purchases for multiple referrers) may be 15. The referral server 106 can calculate a scaling factor (e.g., 38/15) and multiply the scaling factor by a base amount of referral credit 135 (e.g., 0.02) to determine the amount of referral credit to be 0.05. In contrast, a user other than the referrer 101 that has only an average number of sales resulting from referrals would not receive as much referral credit. For an average user, the referral credit may be calculated using a scaling factor of 1 (e.g., 15/15) which would result in referral credit of only the base amount of 0.02 being determined.

Additionally, one or more referral credit policies may be implemented to specify the amount of referral credit awarded for specific media items, classes of media items, types of media, and other factors. For example, a promotion may be implemented during which increased referral credit is determined when the action performed is for a media item 110 included in the promotion. A policy for referral credit may set referral credit to correspond with the value of the media item 110 or the revenue generated by an action related to the media item 110. In other words, the referral credit determined for renting access to a movie may be less than the referral credit for a recipient 103 purchasing perpetual rights to access the same movie. Similarly, the amount of referral credit determined based on a recipient 103 purchasing rights to a song that cost $0.75 may be less than the amount of referral credit determined based on a recipient 103 purchasing rights to a song that cost $1.40.

The referral server 106 can also vary the amount of referral credit determined based on the age or popularity of the media item 110 related to the action. For example, the amount of referral credit can be inversely correlated with the age or popularity of the media item 110, so that actions related to relatively new or relatively not well-known media items 110 can be rewarded with increased referral credit. The referral server 106 may, for example, increase the base value of referral credit for a particular media item 110, increase the scaling factor when the referrer 101 has demonstrated prior success in referring new media items 110, or may add a supplemental amount of referral credit based on the characteristics of one or more media items 110 that have been referred. This can provide increased incentive to referrers 101 to share new media items 110, which is likely to increase the popularity of the new media items 110. Popularity of media items 110 can be determined based on, for example, the number of purchases of the media items 110. Over time, as a media item 110 becomes popular or has been on the market for a certain amount of time, the added incentive to share the particular media item 110 may be discontinued, because the goal of increasing initial popularity or awareness of the media item has been achieved.

During state (G), the referral server 106 provides the determined amount of referral credit 122a to the referrer 101. The referral server 106 may provide the referral credit by adding to the value in a referral account associated with the referrer 101. The referral account may be maintained by the media server 104, for example.

In one implementation, referral credit may be accumulated and applied toward purchases of media items made by the referrer 101. Referral credit may represent a variety of rewards, including monetary value, points redeemable for access to media or other prizes, or other benefits. Referral credit may also represent intangible benefits affecting a status or public profile of a referrer 101.

In some implementations, the referral server 106 may inform the referrer 101 that the referral credit has been provided. This may be accomplished by sending a message to the client device 102a or causing information to be displayed on the client device 102a. Informing the referrer 101 of the referral credit provided may increase the awareness of the referrer 101 that referral credit is available, which may in turn motivate the referrer 101 to share media items 110 with additional recipients 103.

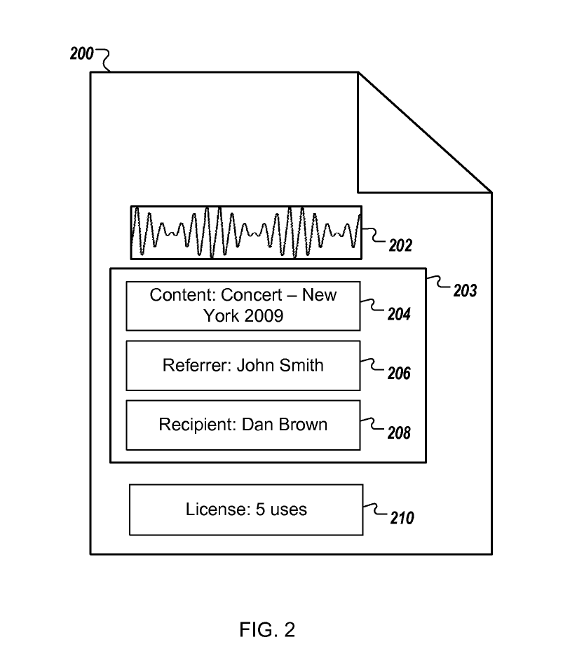

FIG. 2 is a diagram illustrating an example of a message 200 that can be provided by a system that provides incentives for media sharing. The message 200 may be transmitted from a media server to a client device to enable a user to access a media item on the client device.

The message 200 may include media data 202 and a license token 210 enabling access to the media data 202. The message 200 may also include referral metadata 203, such as a media identifier 204, referrer identifier 206, and a recipient identifier 208. The referral metadata 203 may be associated with actions related to the media item so that referral credit is awarded to the referrer when an action is performed.

The media data 202 may include some or all of the media item that a referrer has requested to be shared with the recipient. Alternatively, instead of directly including a media item in message 200, the media data 202 may include a URL, link, or other reference with which access to the media item may be gained. For a media item provided to a client device as a file, the media data 202 may include the entire media item or only a portion of the media item, such as a preview of the media item. Other information, including the license token 210 and referral metadata 203, may be embedded in a file including the media data 202 that is downloaded or otherwise transferred to a client device. For a media item that is streamed from a media server to a client device, the bitstream may be considered the media data 202 of a message 200 and referral metadata 203, may be provided before, during, or after a bitstream of media data 202 is provided.

The media identifier 204 may include a title, product number, code, or other information that identifies the media item. For example, a media identifier 204 may include a product code associated with the media item in a catalog of media items.

The referrer identifier 206 may include a name, user name, phone number, address, e-mail address, client device identifier, or other information identifying the referrer of the media item. The association of a referrer identifier 206 with media data 202 may indicate that the media item was received through sharing and may also indicate the identity of the referrer that shared the media item.

The recipient identifier 208 may include a name, user name, phone number, address, e-mail address, client device identifier, or other information identifying the recipient of the media item.

Providing access to a media item with a message 200 from a media server is only one of many possible ways to provide access to a media item. For example, the information in a message 200 may be packaged into a file by a client device and may be transferred directly from one client device to another client device. Because the transferred file includes the referral metadata 203, when actions occur related to the media item for which media data 202 is included in the file, the client device receiving the file may associate those actions with the referrer, the recipient, and media item.

As an additional example, the information described as being included in a message 200 may be stored entirely on a media server and may not be transmitted to a client device. When a media server is configured to stream media data 202 to a client device, the media server may enforce access restrictions and record or detect actions related to the media item instead of the client device performing those functions. As a result, the client device may have no need to receive the referral metadata 203 or license token 210, making transmission of a message 200 unnecessary.

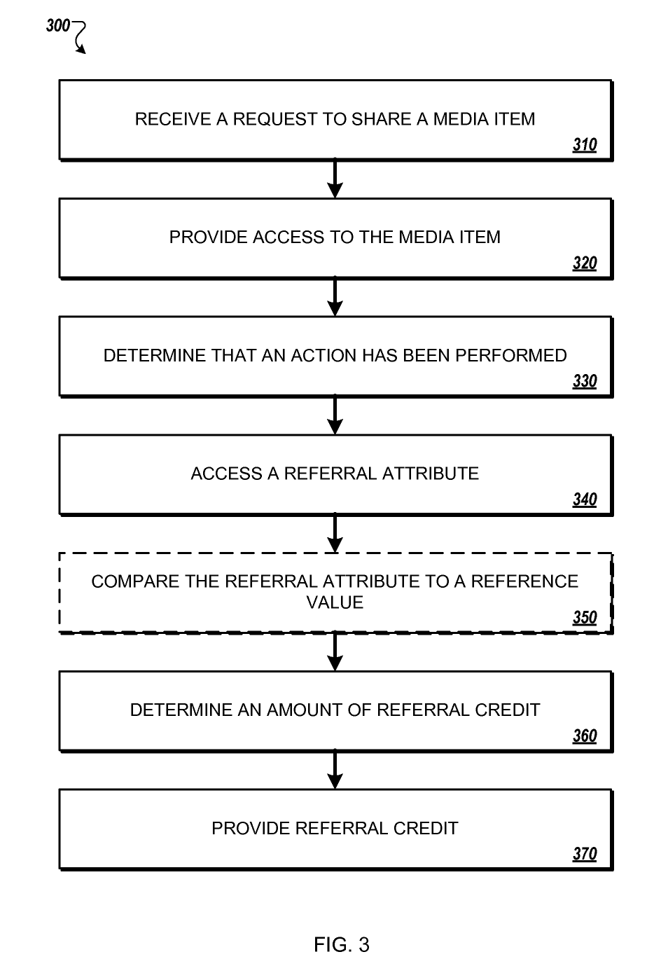

FIG. 3 is a flow chart illustrating an example of a process for providing incentives for media sharing. Briefly, the process 300 includes receiving a request to share a media item, providing access to the media item, determining that an action has been performed, accessing a referral attribute, determining an amount of referral credit using the referral attribute, and providing the referral credit.

To begin the process 300, a server system receives a request from a first user (e.g., a media referrer) to share a media item with a second user (e.g., a media recipient) (310). The request may identify the first user, the second user, and the media item.

In response to receiving the request from the first user to share the media item, the server system provides the second user with access to the media item (320). Providing access to the media item may include providing limited access to the media item, such as providing access to the media item a limited number of times, providing access for a limited period of time, or providing access to a limited portion of the media item. This may include setting and enforcing access restrictions to the media item through DRM techniques. Access to a media item may be achieved by transferring media data to a client device, for example, by streaming the media data, by enabling a file including media data to be downloaded to a client device associated with the second user, or by other transfer methods.

The server system determines that the second user has performed an action related to the media item (330). The determination may be based on a notification from a client device or other system, and may also be based on a transaction database, media access database, and other records.

As described above, an action may include downloading, playing, viewing, rating, reviewing, and sharing the media item as well as purchasing or renting rights to the media item. In some implementations, actions related to the media item are detected when revenue is generated related to the media item. Additionally, actions may be related to the media item when there is a significant likelihood that the second user was exposed to the media item through the action or that the action was intentionally brought about by the second user.

In response to determining that the second user has performed the action related to the media item, the server system accesses a referral attribute associated with the first user (340). The referral attribute is based on correlations among (i) other requests by the first user to share media and (ii) actions by users that, in response to the other requests, receive access to the media. Accessing the referral attribute can include retrieving data and can include generating the referral attribute.

A referral attribute is associated with the first user when, for example, the referral attribute includes a characteristic, value, or attribute of the first user or is linked in some way to the first user's identity. Many referral attributes can be associated with a single user. As further examples, a referral attribute is associated with the first user when it is based on data regarding the preferences, behavior, or tendencies of the first user. Referral attributes can be based on user preferences, user profile information, transaction history, media access history, demographic information, geographic information, social networking connections, and other data related to a user. A referral attribute may be linked directly to a user, such as when information is included in a user profile, or may be indirectly linked, such as when based on data about the first user, regardless of the source of the data. This information may include data about transactions or media accesses of the first user or of other users with whom the first user has shared media items.

Although the referral attribute can be based on information specific a user, the referral attribute associated with the first user is not required to be unique to the first user. For example, the value of a particular referral attribute may be the same for all users that share a particular characteristic, such as an age or location of residence.

The referral attribute accessed is also related to the action that was determined to have been performed. For example, when the action is a purchase of rights to the media item, the referral attribute may be related to purchases, monetary value, or the item purchased. For example, the referral attribute may include a number of purchases rights to media items that have been shared by the first user, a monetary value of purchases of rights to media items that have been shared by the first user, or a measure representing the percentage of users that purchase media items after a media item is shared by the first user out of a group of users with which the first user has requested that the media items be shared. A percentage may be expressed as a rate per hundred, but also more generally as a rate, ratio, fraction, proportion, or other measure of particular items out of a set of items, regardless of the denominator.

A referral attribute is also related to the action when it is related to the particular media item with which the action is related. For example, when the action is viewing a particular movie, a referral attribute for the first user may be whether the first user has posted a review of the movie. Other examples include the number of times the referrer has shared a particular media item or the percentage of users that have played a particular media item after the first user requested that the media item be shared.

The referral attribute may also be independent of the particular media item that is the subject of the determined action. For example, for a purchase of a media item by the second user, the referral item may include a value of purchases of rights to media items by users with whom the first user had previously shared the purchased media items, even if none of the prior purchases include purchases related to the particular media item shared with the second user.

Optionally, the server system may compare the referral attribute to a reference value (350). The server system may compare the referral attribute to a reference value to calculate a scaling factor. For example, the server system may calculate a value that indicates the relationship between the referral attribute and the reference value. Comparing may also include determining a relationship between the referral attribute and the reference value. Examples include determining whether the referral attribute is greater than, less than, equal to, or not equal to the reference value. Similarly, comparing may include determining whether a referral attribute includes, matches, or partially matches the reference value or exhibits other relationships with the reference value.

The reference value represents a standard or other measure to which a referral attribute may be compared. The reference value may be a predetermined value or may be set dynamically. The reference value may be based on information including referral attributes of one or more users, data on which one or more referral attributes is based, and other statistics and measures.

Significantly, the reference value may be determined so that comparison with the referral attribute of a user may be used to identify users with a high degree of influence on other users. One measure of influence may include the degree or frequency at which recipients of shared media items perform actions related to the shared media items. The reference value may be based on absolute values (e.g., the number “10”) or relative values (e.g., “10 more than average”). A specific reference value may apply to a single media item, a group of media items, a specific type of media (e.g., music or books), or to all media.

The type of data represented by reference value may correspond with the type of data represented by the referral attribute. For example, when the referral attribute includes a monetary value of purchases, the reference value may include a monetary value. When the referral attribute includes a number of views, the reference value may include a number of views.

Using the referral attribute the server system determines an amount of referral credit (360). The amount of referral credit may be based on a fixed amount, a variable amount, or may combine fixed and variable amounts.

Determining an amount of referral credit is based, at least in part, on the comparison between the referral attribute and the reference value. For example, the amount of referral credit may be determined by multiplying a base amount of referral credit by scaling factor that reflects a comparison between the referral attribute and the reference value. The scaling factor, which can be based on both the referral attribute and the reference value, may be higher for influential referrers than for less influential referrers. For example, a first amount of referral credit may be determined based on a comparison indicating that a lower than average percentage of users with whom the first user shares media items ultimately purchase the shared media items. A second amount of referral credit greater than the first amount may be determined based on a comparison indicating that a higher than average percentage of users with whom the first user shares media items ultimately purchase the shared media items.

Determining an amount of referral credit may be based on information about the media item for which the action occurred. In other words, the amount of referral credit may be based on factors such as the popularity, identity, quality, value, publisher, creator, or creation date of the media item. For example, the amount of referral credit may be increased for a media item of higher than average sales value. A promotion may also be implemented, in which actions related to a certain media item result in higher referral credit than for other media.

In addition, the referral server may take into account the status of the first user and determine higher amounts of referral credit for users that have extensive social networking connections, have high personal rates of purchasing media, or meet other criteria. In particular, the referral credit may be increased for referrers that strongly influence other users to purchase media early in the product cycle, when the media is not yet widely popular. Determining an amount of referral credit based on one or more these factors may be implemented and facilitated by a comparison between an appropriate referral attribute and reference value. Similarly, the amount of referral credit determined may be based in part on attributes of the second user that performed the action related to the media item. For example, a large amount of referral credit may be determined for the first user when the second user that performs the determined action has purchased a high value of media items in the past.

The server system provides the determined amount of referral credit to the first user (370). As described above, the referral credit may be added to an account associated with the first user.

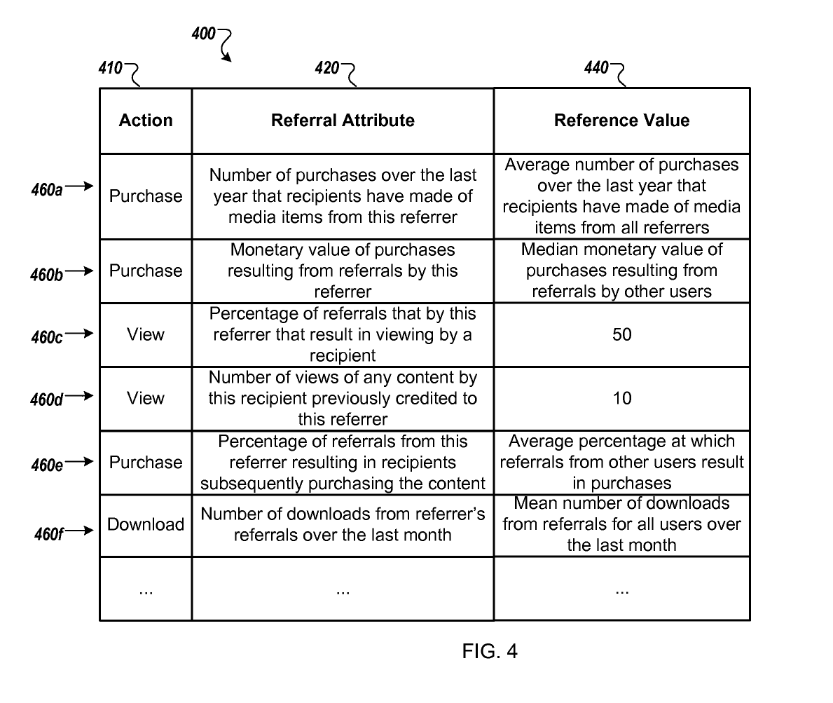

FIG. 4 is a table 400 illustrating examples of information used by a system for media sharing. The table 400 includes an action column 410, a referral attribute column 420, a relationship column 430, a reference value column 440, and an additional referral credit column 450. The table 400 includes various rows 460a-460f, and the entries within each row are related to each other.

Referring to FIG. 4, the action column 410 identifies a number of actions related to media items that are possible. For each row of the table 400, the entry in the action column 410 indicates the action with which the other entries are related.

As shown, there may be multiple entries for a single type of action. For example, there are three rows in the table 400 relating to “purchase” actions, each corresponding with different referral attributes. When a server system determines that a purchase action has occurred, the server system may select one or more of the rows of the table 400 to use in determining whether additional referral credit (that is, credit in addition to a base referral credit amount) should be provided and in what amount.

The referral attribute column 420 includes entries that describe types of data included in various referral attributes. When an action related to a media item occurs, the server system determines the value of the referral attribute associated with the referrer that initially referred the media item. As a result, the value used by the server system is a referral attribute of the referrer. Nevertheless, a referral attribute of a referrer is not required to be unique. Multiple referrers may share one or more referral attributes.

The reference value column 440 includes entries that describe types of data in various reference values. The entry in the reference value column 440 may correspond to the entry in the referral attribute column 420 of the same row. Thus the referral attribute in one row may be compared with the reference value in the same row.

The data shown in the referral attribute column 420 and reference value column 440 describe the general type of information included in the referral attribute or reference value, not the actual numbers or values that would be compared. The referral attribute and reference value may be evaluated to determine a specific measure in relation to each instance of an action related to a media item. The value of the referral attributes and reference values compared may be numbers, dollar amounts, text, or other measures of the criteria described in the referral attribute column 420 and reference value column 440.

For example, a referrer may request that a media item be shared with a recipient, the recipient may subsequently purchase rights to access the media item, and a server system may determine that the recipient has purchased rights to access the media item. The server system may then refer to a table 400 or other source of information. The server system may select a row 460a-460f that corresponds to the purchase of rights to access a media item. The server system may select row 460b, for example, because the entry in the action column 410 includes a “purchase,” and the action related to the media item is a purchase.

The server system may also access the referral attribute of the referrer specified by the entry in the referral attribute column 420. The referral attribute may be the “monetary value of purchases resulting from referrals by this referrer,” or in other words, the monetary value of purchases of rights to access media items, in which the purchases are made by recipients with whom the referrer requested that media items be shared, and the purchased media items were media items that the referrer requested to be shared. Accessing the referral attribute may result in, for example, a value of $38.75. The server system may also access the reference value specified by the entry in the reference value column 440, and determine that the median monetary value of purchases resulting from referrals by other users is $27.50.

The server system may use the referral attribute to determine an amount of referral credit, for example, by determining a scaling factor using the referral attribute. As an example, the scaling factor reflect a comparison between the referral attribute and the reference value, such as dividing the referral attribute by the reference value (e.g., $38.75/$27.50=1.41). The server system can then multiply the scaling factor by a base amount of referral credit to determine the particular amount of referral credit to award to the referrer.

In some implementations, different referral credit incentives may be used for various referrers. The row 460a-460f, and thus the referral attribute, reference value, and referral calculation method may vary over time and may vary from one referrer to another. A server system may record information about the effectiveness of various referral credit calculations in generating new referrals and sales. The referral credit calculations that most effectively result in additional referrals and sales can be implemented more widely for many referrers.

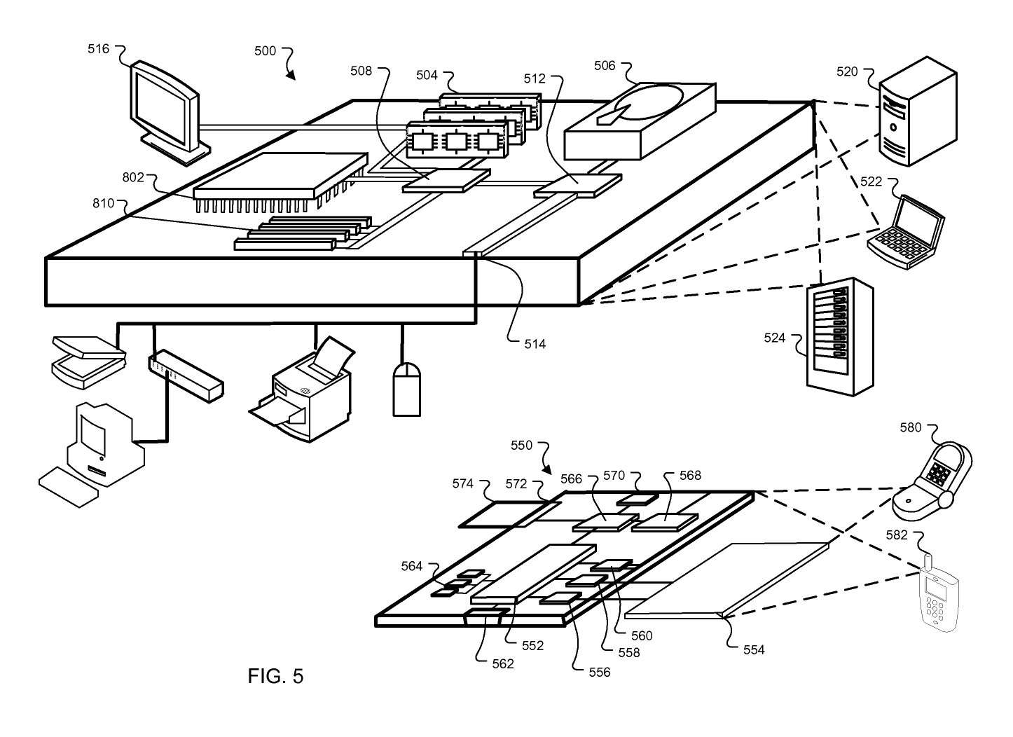

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. Additionally computing device 500 or 550 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface controller 508 connecting to memory 504 and high-speed expansion ports 510, and a low speed interface controller 512 connecting to a low-speed expansion port 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high-speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high-speed interface controller 508 manages bandwidth-intensive operations for the computing device 500, while the low-speed interface controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing devices 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive, solid state storage component, or other device, to provide additional storage. Each of the components 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. Additionally, the processor may be implemented using any of a number of architectures. For example, the processor 502 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552 that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made. For example, various forms of the flows shown above may be used, with steps re-ordered, added, or removed. Also, although several applications of providing incentives for media sharing and methods have been described, it should be recognized that numerous other applications are contemplated. Accordingly, other embodiments are within the scope of the following claims.

What is claimed is:

1. A method, comprising:
receiving a request from a first user to share a media item with a second user;
in response to receiving the request from the first user to share the media item, providing the second user with access to the media item;
determining that the second user has purchased rights to the media item;
in response to determining that the second user has purchased rights to the media item, accessing a referral attribute associated with the first user, the referral attribute being related to the action and being based on correlations among (i) other requests by the first user to share media and (ii) actions by users that, in response to the other requests, receive access to the media;
comparing the referral attribute to a reference value;
based on comparing the referral attribute to the reference value, determining an amount of referral credit such that
a first amount of the referral credit is determined if the referral attribute is greater than the reference value, and
a second amount of the referral credit is determined if the referral attribute is less than the reference value, the second amount of referral credit being less than the first amount of referral credit; and
providing the determined amount of referral credit to the first user.

2. The method of claim 1 wherein providing the second user with access to the media item comprises providing the second user with access to the media item a limited number of times.

3. The method of claim 1 wherein determining an amount of referral credit comprises determining an amount of referral credit based on the age or popularity of the media item, wherein the amount of referral credit is inversely correlated with the age or popularity of the media item.

4. The method of claim 1 wherein the referral attribute comprises a monetary value of purchases or number of purchases of rights to one or more media items, the purchases being correlated with one or more requests by the first user that each of the one or more media items be shared with one or more other users, the monetary value of purchases or number of purchases including information about at least one purchase by a user with whom the first user did not request that the media item be shared.

5. The method of claim 1 wherein determining an amount of referral credit comprises adding a supplemental amount of referral credit to a base value of referral credit, the supplemental amount of referral credit being based on the comparison.

6. The method of claim 1 wherein determining an amount of referral credit comprises multiplying a base value of referral credit by a scaling factor based on the comparison.

7. The method of claim 6 wherein the referral attribute comprises a monetary value of purchases or number of purchases of rights to the media item by users with whom the first user has requested the media item be shared.

8. The method of claim 7 wherein the reference value comprises, for a set of users that have requested that the media item be shared, an average monetary value of purchases or average number of purchases of rights to the media item by users with whom at least one of the set of users has requested the media item be shared.

9. The method of claim 6 wherein the referral attribute comprises a monetary value of purchases or number of purchases of rights to at least one of a plurality of media items by users with whom the first user has requested the at least one of the plurality of media items be shared.

10. The method of claim 9, wherein the reference value comprises an average monetary value of purchases or average number of purchases of rights to at least one of the plurality of media items by users with whom a plurality of users have requested at least one of the media items be shared.

11. The method of claim 6, wherein the referral attribute comprises a percentage of requests from the first user to share at least one of a plurality of media items resulting in a purchase of rights to the at least one of the plurality of media items by a user with whom the first user has requested that the at least one of the plurality of media items be shared.

12. The method of claim 11 wherein the referral attribute comprises a number of users that have accessed the media item out of a set of users with whom the first user has requested the media item be shared.

13. A system comprising:
one or more computers; and
a computer-readable medium coupled to the one or more computers having instructions stored thereon which, when executed by the one or more computers, cause the one or more computers to perform operations comprising:
receiving a request from a first user to share a media item with a second user;
in response to receiving the request from the first user to share the media item, providing the second user with access to the media item;
determining that the second user has performed an action related to the media item;
in response to determining that the second user has performed the action related to the media item, accessing a referral attribute associated with the first user, the referral attribute being related to the action and being based on correlations among (i) other requests by the first user to share media and (ii) actions by users that, in response to the other requests, receive access to the media;
comparing the referral attribute to a reference value;
based on comparing the referral attribute to the reference value, determining an amount of referral credit; and
providing the determined amount of referral credit to the first user.

14. The system of claim 13 wherein the referral attribute comprises a monetary value of purchases or number of purchases of rights to one or more media items, the purchases being correlated with one or more requests by the first user that each of the one or more media items be shared with one or more other users.

15. The system of claim 13 wherein the action related to the media item comprises accessing the media item.

16. The system of claim 13 wherein:
the action related to the media item comprises purchasing rights to the media item; and
the referral attribute comprises a monetary value of purchases or number of purchases of rights to at least one of a plurality of media items by users with whom the first user has requested the at least one of the plurality of media items be shared;

17. The system of claim 13 wherein:
the reference value comprises an average monetary value of purchases or average number of purchases of rights to at least one of the plurality of media items by users with whom a plurality of users have requested at least one of the media items be shared; and
determining an amount of referral credit comprises determining a first amount of the referral credit if the referral attribute is greater than the reference value and determining a second amount of the referral attribute is less than the reference value, the first amount being greater than the second amount.

18. A computer storage medium encoded with a computer program, the program comprising instructions that when executed by one or more computers cause the one or more computers to perform operations comprising:
receiving a request from a first user to share a media item with a second user;
in response to receiving the request from the first user to share the media item, providing the second user with access to the media item;
determining that the second user has performed an action related to the media item;
in response to determining that the second user has performed the action related to the media item, accessing a referral attribute associated with the first user, the referral attribute being related to the action and being based on correlations among (i) other requests by the first user to share media and (ii) actions by users that, in response to the other requests, receive access to the media;
comparing the referral attribute to a reference value;
based on comparing the referral attribute to the reference value, determining an amount of referral credit; and
providing the determined amount of referral credit to the first user.

19. The computer storage medium of claim 18 wherein:
the action related to the media item comprises purchasing rights to the media item; and
the referral attribute comprises a monetary value of purchases or number of purchases of rights to at least one of a plurality of media items by users with whom the first user has requested the at least one of the plurality of media items be shared.

20. The computer storage medium of claim 19 wherein:
the reference value comprises an average monetary value of purchases or average number of purchases of rights to at least one of the plurality of media items by users with whom a plurality of users have requested at least one of the media items be shared; and
determining an amount of referral credit based on comparing the referral attribute of the first user to a the reference value comprises determining a first amount of the referral credit if the referral attribute is greater than the reference value and determining a second amount of the referral attribute is less than the reference value, the first amount being greater than the second amount.
